(19) United States
(12) Patent Application Publication
(10) Pub. No.: US 2026/0030444 A1
(43) Pub. Date: Jan. 29, 2026

(54) DYNAMICALLY ADJUSTING RESPONSE PARAMETERS OF A LARGE LANGUAGE MODEL DURING AN INTERACTION WITH A USER

(71) Applicant: Red Hat, Inc., Raleigh, NC (US)

(72) Inventors: Mario Fusco, Gorgonzola (IT); Luca Molteni, Cernusco Sul Naviglio (IT)

(21) Appl. No.: 18/783,023

(22) Filed: Jul. 24, 2024

(51) Int. Cl. G06F 40/20

(52) U.S. Cl. CPC G06F 40/20

(57) ABSTRACT

In one example, a system can input a first system prompt to a large language model (LLM). The first system prompt includes a first set of response parameters. The LLM can enter a first functional state based on receiving the first system prompt. While in the first functional state, the LLM can be used to engage in an interaction with a user to thereby generate interaction content. The system can then determine that a condition is satisfied based on the interaction content and, in response, input a second system prompt to the LLM. The second system prompt includes a second set of response parameters that is different from the first set of response parameters. The LLM can enter a second functional state based on receiving the second system prompt. While in the second functional state, the LLM can be used to continue the interaction with the user.

### TECHNICAL FIELD

The present disclosure relates generally to large language models. More specifically, but not by way of limitation, this disclosure relates to dynamically adjusting response parameters of a large language model during an interaction with a user, which can improve the versatility and accuracy of the large language model.

### BACKGROUND

Large language models (LLMs) have recently exploded in popularity. An LLM is a deep learning algorithm that may recognize, summarize, translate, predict, and generate text and other content based on knowledge gained from being trained on massive training datasets. One example of an LLM is a generative pre-trained transformer (GPT) model, though other kinds of LLMs exist. A popular GPT model is GPT-4, which is produced by OpenAIR of San Francisco, California.

### BRIEF DESCRIPTION OF THE DRAWINGS

FIG. 1 shows a block diagram of an example of a system for dynamically adjusting response parameters of a large language model during an interaction with a user, according to some aspects of the present disclosure.

FIG. 2 shows examples of system prompts according to some aspects of the present disclosure.

FIG. 3 shows a flow chart of an example of a process for dynamically adjusting response parameters of a large language model during an interaction with a user, according to some aspects of the present disclosure.

FIG. 4 shows a block diagram of an example of a system for dynamically adjusting response parameters of a large language model during an interaction with a user, according to some aspects of the present disclosure.

FIG. 5 shows a flow chart of an example of a process for dynamically adjusting response parameters of a large language model during an interaction with a user, according to some aspects of the present disclosure.

### DETAILED DESCRIPTION

Large language models (LLM) are often used in chat bots to engage in interactions with users. Such an LLM may be constructed, trained, and ultimately deployed for usage in a chat bot. After the LLM is deployed, but before an interaction with a user begins, the LLM may be configured using a system prompt. A system prompt is a type of input prompt that is provided by the computer system (as opposed to the user) to the LLM to guide how the LLM interprets and/or responds to user inputs. A system prompt can include instructions that initialize the LLM with certain contextual information and response parameters. A response parameter is a parameter that controls (e.g., constrains) how the LLM responds to user inputs during the interaction. For example, the response parameters may control the tone, length, and/or style of the LLM's responses. Response parameters are different from the LLM's hyperparameters and its internal weights. Rather, the response parameters are provided as input to the LLM via a system prompt after the LLM has already been designed, trained, and deployed. Once the LLM is initialized with a system prompt, the user may then be allowed to engage in an interaction with the chat bot.

In a typical scenario, a single system prompt is used to initialize the LLM with certain contextual information and response parameters before an interaction (e.g., conversation) with the user begins. This can control the behavior of the LLM during the interaction. After the LLM is initialized using the system prompt, the user can then engage in the interaction with the LLM. Throughout the course of the interaction, the response parameters of the LLM normally remain the same (fixed). But this can be problematic because an interaction can drift over time, for example in its topic or purpose. As a result, the LLM's response parameters may become stale as the interaction progresses, which may lead to hallucinations, inaccuracies, and other problems with the operation of the LLM.

Some examples of the present disclosure can overcome one or more of the abovementioned problems by automatically and dynamically adjusting the response parameters of an LLM during an interaction with a user. The response parameters can be dynamically adjusted based on the content of the interaction. For instance, the LLM's response parameters can be automatically and dynamically adjusted multiple times over the course of the interaction by inputting a series of system prompts to the LLM. These system prompts can be input to the LLM transparently in the background, unbeknownst to the user, while the interaction is ongoing. Each system prompt can be input to the LLM based on the system detecting that a corresponding condition has been satisfied by the content of the interaction. Through this process, the response parameters of the LLM can be repeatedly adjusted over the course of the interaction in real time, which can allow the LLM to effectively handle interaction drift, thereby providing for improved accuracy and flexibility of the LLM.

In some examples, the system can execute a rule engine to determine whether the conditions are satisfied. For example, the rule engine can evaluate the content of the interaction, determine if a condition is satisfied by the content of the interaction, select an appropriated system prompt based on the satisfied condition, and input the system prompt to the LLM. The rule engine can iteratively perform these steps in real time while the interaction is ongoing.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

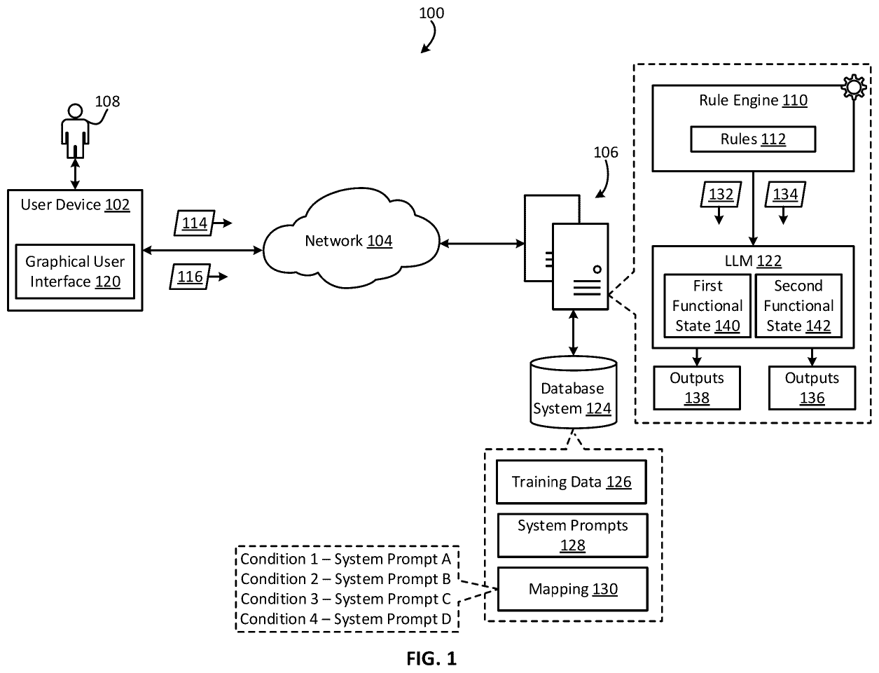

FIG. 1 shows a block diagram of an example of a system 100 for dynamically adjusting response parameters of a large language model during an interaction with a user 108, according to some aspects of the present disclosure. The system 100 includes a computing system 106 with an LLM 122. The computing system 106 can include any number and combination of computing devices, such as servers, desktop computers, and laptop computers. The computing system 106 can have any suitable architecture. For example, the computing system 106 may be a cloud computing system, a computing cluster, or another type of distributed computing system.

Prior to its deployment in a live chat bot (e.g., in a production environment), the LLM 122 may be trained using training data 126. The training data 126 may be stored in a database system 124. The training data 126 may include thousands or millions of texts. Reinforcement learning techniques may also be used to improve the accuracy of the LLM 122 for a particular purpose or domain.

After the LLM 122 is trained, the LLM 122 can be deployed for use in a live chatbot with which a user 108 can interact. For instance, the user 108 may have the ability to enter a message 114 for the LLM 122 in a graphical user interface 120, which can be displayed on a user device 102 of the user 108. Examples of the user device 102 may include a laptop computer, desktop computer, tablet, e-reader, wearable device (e.g., smart watch), or a mobile telephone (e.g., smartphone). The message 114 may include a statement, a question, or a request for information. The user device 102 can then transmit the message 114 to the computing system 106 via one or more networks 104, such as a local area network or the Internet. The computing system 106 can receive the message 114 and provide it as input to the LLM 122. In response to receiving the message 114, the LLM 122 can generate an output 138, such as a textual response. The computing system 106 can then provide the output 138 from the LLM to the user 108. For example, the computing system 106 can transmit the output 138 to the user device 102 for display in the graphical user interface 120. The user 108 may then respond to the output 138 with a follow-up message 116 and the process can repeat. In this way, the user 108 may be able to engage in a back-and-forth interaction (e.g., conversation) with the LLM 122.

After the user 108 requests to start an interaction session with the LLM 122, but prior to allowing a message from the user 108 to be input to the LLM 122, the computing system 106 may provide a system prompt 132 to the LLM 122 to prepare it for the interaction. The system prompt 132 can include one or more response parameters that control the responses of the LLM 122 during the interaction session. In a typical scenario, that may be the only system prompt provided throughout the entire interaction session. But this can be problematic if there is interaction drift (e.g., the interaction drifts away from its initial topic or purpose to a new topic or purpose). Such interaction drift may cause the response parameters, which were provided at the start of the interaction session, to eventually become stale. This can lead to suboptimal performance of the LLM 122.

To help overcome one or more of the abovementioned problems, the computing system 106 can execute a rule engine 110. The rule engine 110 can monitor the content of the interaction in real time (e.g., as it is ongoing). The rule engine 110 can apply a predefined set of rules 112 to the content of the interaction to detect whether and when one or more conditions are satisfied. If a condition is satisfied, the rule engine 110 can determine a system prompt 134 that corresponds to the condition. The rule engine 110 may make this determination using a predefined mapping 130, which correlates conditions to system prompts. Depending on which condition is satisfied, the rule engine 110 can select the corresponding system prompt 134 in the mapping 130 and provide it as input to the LLM 122. The selected system prompt 134 may include one or more response parameters that are different from those of the initial system prompt 132 used to initialize the LLM 122 at the start of the interaction. The rule engine 110 may iterate this process multiple times over the course of the interaction, as conditions are sequentially satisfied by the content of the interaction. In this way, the rule engine 110 can dynamically adjust the response parameters of the LLM 122 throughout the interaction. Doing so can help the LLM 122 provide responses that are more accurate and relevant to the current topic or objective of the interaction, as the interaction drifts over time.

As one particular example, the user 108 may request to initiate an interaction session (e.g., a conversation session) with the LLM 122. In response to this request, the computing system 106 can provide a first system prompt 132 as input to the LLM 122 to initialize the LLM 122 for the interaction. The first system prompt 132 can include a first set of response parameters, which may serve as a default set of response parameters. The first set of response parameters can include one or more response parameters. Examples of the response parameters can include a role parameter, which can control a role or part played by the LLM 122 during the interaction; a length parameter, which can control the length of the LLM's responses to user messages; a tone parameter, which can control the tone of the LLM's responses to user messages; or any combination of these. Based on the first system prompt 132, the LLM 122 can enter a first functional state 140. In the first functional state 140, the LLM 122 can be required to conform to the first set of response parameters.

Once the LLM 122 is in the first functional state, the computing system 106 may allow the user 108 to begin transmitting messages 114 to the LLM 122. The messages 114 may be in a natural language format. The computing system 106 can input the messages 114 to the LLM 122. In response, the LLM 122 may generate one or more outputs 138 based on the one or more messages 114. The outputs 138 may be responses to the messages 114. The outputs 138 may also be in a natural language format. The computing system 106 can then provide the one or more outputs 138 to the user 108. For example, the computing system 106 can transmit the one or more outputs 138 to the user device 102 for display in the graphical user interface 120. The messages 114 and/or outputs 138 may constitute first interaction content.

The rule engine 110 can analyze the first interaction content as the interaction session is ongoing. For example, the computing system 106 may provide the first interaction content as input to the rule engine 110. The computing system 106 may provide some or all of the first interaction content as input to the rule engine 110 in response to detecting one or more events. Examples of such events can include the passage of a certain time period, detecting one or more predefined keywords, the receipt of a certain number of messages from the user, and/or the generation of a certain number of outputs from the LLM 122. The rule engine 110 can apply the predefined set of rules 112 to the first interaction content to determine whether one or more conditions are satisfied by the first interaction content. The rules 112 can include logic that indicates when each condition is satisfied based on interaction content. The conditions can correspond to transition points in the interaction, such as changes in the topic, objective, sentiment, tone, and/or other characteristics of the interaction. For instance, the rules 112 may indicate that a condition is satisfied if the first interaction content includes a certain amount or kind of information, which may suggest a change in the topic or purpose of the interaction.

In response to detecting that a condition is satisfied, the rule engine 110 can determine a second system prompt 134 that corresponds to the condition. For example, the rule engine 110 can use the predefined mapping 130 to lookup which system prompt corresponds to the condition. After identifying the appropriate system prompt using the mapping 130, the rule engine 110 can obtain the selected system prompt from among a set of system prompts 128, which may be stored in a repository (e.g., of the database system 124). The set of system prompts 128 may be predefined, and their mappings to conditions may be predefined, by one or more users. Each of the system prompts 128 can include a respective set of response parameters, some or all of which may be different from those of the other system prompts.

Having selected the second system prompt 134, the computing system 106 can input the second system prompt 134 to the LLM 122. The second system prompt 134 can include a second set of response parameters, which may be different from the first set of response parameters. The second set of response parameters can include one or more response parameters. Based on the second system prompt 134, the LLM 122 can enter a second functional state 142. The second functional state 142 can be different from the first functional state 140. In the second functional state 142, the LLM 122 can be required to conform to the second set of response parameters.

While the LLM 122 is in the second functional state 142, the user 108 may continue to transmit additional messages 116 to the LLM 122. Thus, the user 108 may continue the interaction with the LLM 122 after the LLM 122 has transitioned from the first functional state to the second functional state. The additional messages 116 may be in a natural language format. The computing system 106 can input the additional messages 116 to the LLM 122. Based on the one or more additional messages 116, the LLM 122 may generate one or more additional outputs 136. The additional outputs 136 may be responses to the messages 116. The additional outputs 136 may also be in a natural language format. The computing system 106 can then provide the one or more additional outputs 136 to the user 108. For example, the computing system 106 can transmit the additional outputs 136 to the user device 102 for display in the graphical user interface 120. The additional messages 116 and/or outputs 136 may constitute second interaction content.

As the interaction continues, the above process can repeat. For example, the rule engine 110 may determine that another condition has been satisfied based on the first interaction content and/or the second interaction content. As a result, the rule engine 110 may select and provide a third system prompt as input to the LLM 122, thereby updating the LLM's response parameters again. This can cause the LLM 122 to enter a third functional state, which may be different from the second functional state 142. In some examples, the third functional state may be the same as the first functional state—e.g., the LLM 122 may return to the first functional state 140 based on the third system prompt. Alternatively, the third functional state may be different from both the first functional state 140 and the second functional state 142.

Through the above process, the rule engine 110 can automatically and dynamically adjust the response parameters of the LLM 122 over the course of the interaction. This is achieved by providing a sequence of system prompts as input to the LLM 122 based on the sequence of conditions satisfied during the interaction. Because the conditions can correspond to transition points in the interaction, the rule engine 110 can effectively identify these transition points and update the response parameters accordingly. This can improve the performance of the LLM 122 as the interaction drifts over time.

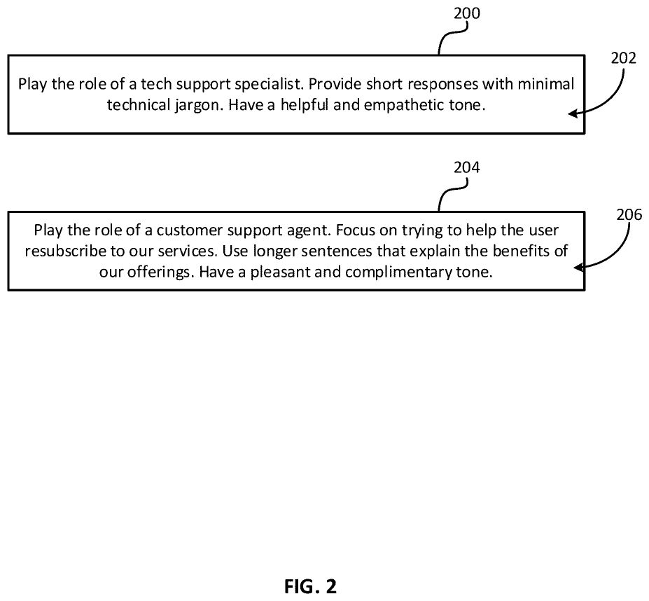

Turning now to FIG. 2, shown are examples of system prompts 200, 204 according to some aspects of the present disclosure. These system prompts 200, 204 may be used in relation to an interaction between a user and a chat bot. In this example, the user may access the chat bot because they are having trouble with a cloud software product. When the user requests to start an interaction session with the chat bot, the system may initialize the LLM with the first system prompt 200 prior to the start of the interaction. The first system prompt 200 include a first set of response parameters 202 that can initialize the LLM to a first functional state, in which the LLM is focused on providing technical support to the user to help solve the user's problem with the cloud software product. As shown, the first set of response parameters 202 may be provided in a natural language format in the first system prompt 200.

At some point in the interaction, it may become apparent that the user is having trouble with the cloud software product because they let their subscription lapse, which resulted in certain features being disabled. This may be an example of a condition that is detected by the rule engine based on the content of the interaction up to that point. In response to detecting this condition, the rule engine can provide the second system prompt 204 as input to the LLM. The second system prompt 204 include a second set of response parameters 206 that can configure the LLM with a second functional state, in which the LLM may be focused on helping the user to reinstate their subscription. As shown, the second set of response parameters 206 may also be provided in a natural language format in the second system prompt 204.

While the LLM is in the second functional state, the user may continue to chat with the LLM. Of course, now the characteristics (e.g., tone, length, and/or style) of the responses from the LLM may be different from the earlier portion of the interaction. In this way, the system can detect a transition in the interaction that may warrant an update to the response parameters and make such an update accordingly, which can allow the LLM to better cope with the new direction of the interaction.

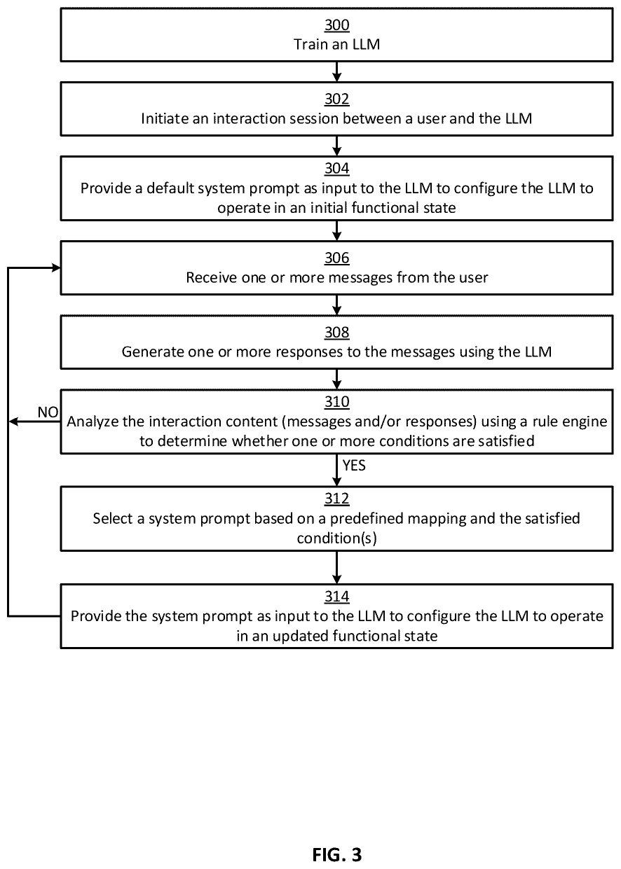

Turning now to FIG. 3, shown is a flow chart of an example of a process for dynamically adjusting response parameters of a large language model during an interaction with a user, according to some aspects of the present disclosure. Other examples may include more steps, fewer steps, different steps, or a different sequence of steps than is shown in FIG. 3. The operations of FIG. 3 are described below with reference to the components of FIG. 1 described above.

In block 300, a computing system 106 trains an LLM 122 based on training data 126. This may involve tuning the weights of the LLM 122 to transform the LLM 122 from an untrained state to a trained state. The training data 126 may include a large corpus of text from reviews, books, articles, websites, newspapers, social media, blogs, academic papers, e-mails, or any combination of these. The LLM 122 may undergo one or more training phases. In some examples, the LLM 122 may undergo one or more validation phases after the one or more training phases. This can help confirm the LLM's accuracy before it is deployed for live use. The remainder of the steps of FIG. 1 may occur after the LLM 122 is trained and validated.

In block 302, the computing system 106 initiates an interaction session between a user 108 and the LLM 122. For example, the computing system 106 can receive a request to initiate an interaction from the user 108 and responsively perform one or more actions to initiate the interaction session. One example of such an action may include deploying an instance of the LLM 122 that may be dedicated to the interaction session.

In block 304, the computing system 106 provides a default system prompt, such as the first system prompt 132, as input to the LLM 122. This can configure the LLM 122 to operate in an initial functional state, such as the first functional state 140. In the initial functional state, the LLM 122 may conform to one or more response parameters supplied in the default system prompt.

In some examples, the computing system 106 can provide the default system prompt as input to the LLM 122 before any messages for the LLM are received from the user 108. Alternatively, if one or more messages have already been received from the user, they can be buffered and the computing system 106 can provide the default system prompt as input to the LLM 122 before allowing such messages to be input to the LLM 122.

In block 306, the computing system 106 receives one or more messages 114 from the user 108. The messages 114 may be received from a user device 102 of the user 108 via one or more networks 104.

In block 308, the computing system 106 generates one or more responses to the one or more messages 114 using the LLM 122. For example, the computing system 106 can input the one or more messages 114 to the LLM 122, which can generate one or more outputs 138 based on the one or more messages 114. The one or more outputs 138 can serve as the one or more responses.

In block 310, the computing system 106 analyzes the interaction content to determine whether one or more conditions are satisfied. The interaction content can include the messages 114, the responses, or both. A rule engine 110 can be used to analyze the interaction content to determine whether the one or more conditions are satisfied. The rule engine 110 can apply a set of rules 112 to the interaction content to determine whether at least one condition is satisfied by the interaction content. In some examples, the rule engine 110 may apply one or more models, such as trained machine-learning models, to determine whether a condition is satisfied by the interaction content.

In some examples, a condition may be satisfied if the interaction content includes a certain keyword or combination of keywords. Additionally, or alternatively, a condition may be satisfied if the interaction content includes a certain amount of information, such as a threshold amount of information about the user 108 or a product used by the user 108. Additionally, or alternatively, a condition may be satisfied if the interaction content includes certain types of information, such as the user's demographic information and/or preferences. Additionally, or alternatively, a condition may be satisfied if the sentiment of the user 108 changes during the interaction. The sentiment may be gauged using a sentiment model, which may be a trained machine-learning model as is known in the art. Additionally or alternatively, a condition may be satisfied if a predefined period of time has passed (e.g., since the interaction began or the last condition was satisfied).

If at least one condition is satisfied by the interaction content, the process can continue to block 312. Otherwise, the process can return to block 306.

In block 312, the computing system 106 selects a system prompt 134 based on a predefined mapping 130 and the satisfied condition(s). For example, the computing system 106 can select the system prompt 134 by determining which system prompt corresponds to the satisfied condition(s) in the predefined mapping 130. If more than one condition is satisfied by the interaction content, a predefined prioritization scheme can be applied to select among the corresponding system prompts.

In block 314, the computing system 106 provides the selected system prompt 134 as input to the LLM 122 to configure the LLM 122 to operate in an updated functional state, which is different from the previous functional state (e.g., the initial functional state). In the updated functional state, the LLM 122 may conform to one or more response parameters provided in the selected system prompt 134. The process may then return to block 306 and repeat.

Eventually, the interaction session may be terminated-e.g., by the user. At that point, the LLM instance may be shutdown to conserve computing resources. Alternatively, the LLM instance may be reinitialized for a future interaction session with the same user or a different user.

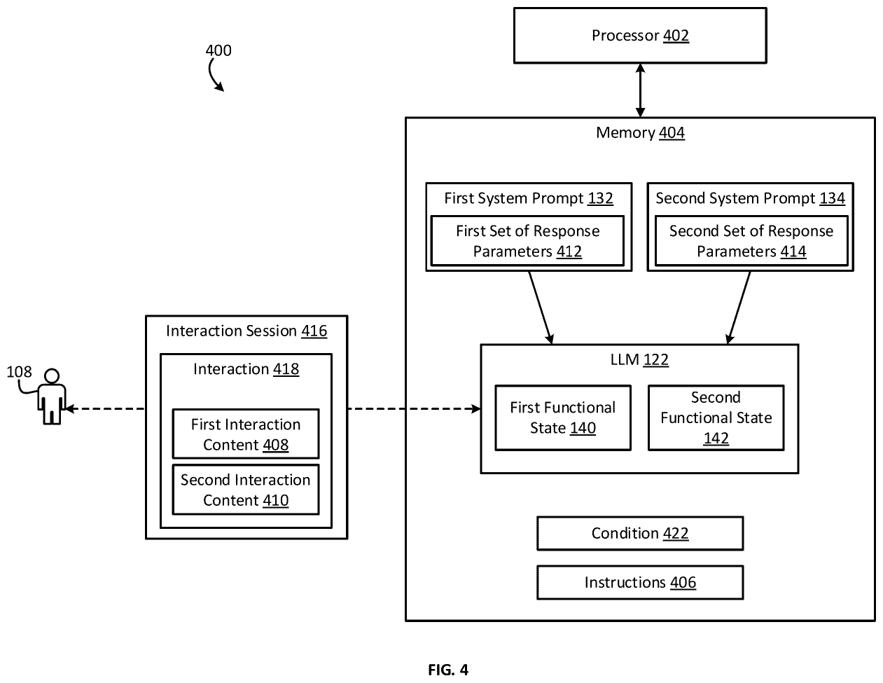

Turning now to FIG. 4, shown is a block diagram of an example of a system 400 for dynamically adjusting response parameters of a large language model 122 during an interaction, according to some aspects of the present disclosure. The system 400 can include a processor 402 communicatively coupled to a memory 404. In some examples, the processor 402 and memory 404 may correspond to the computing system 106 of FIG. 1.

The processor 402 can include one processing device or multiple processing devices. Non-limiting examples of the processor 402 include a Field-Programmable Gate Array (FPGA), an application-specific integrated circuit (ASIC), a microprocessor, or any combination of these. The processor 402 can execute instructions 406 stored in the memory 404 to perform operations, such as any of the operations described herein with respect to the computing system 106. In some examples, the instructions 406 can include processor-specific instructions generated by a compiler or an interpreter from code written in any suitable computer-programming language, such as C, C++, C#, Python, or Java.

The memory 404 can include one memory device or multiple memory devices. The memory 404 can be volatile or non-volatile, such that the memory 404 retains stored information when powered off. Non-limiting examples of the memory 404 include electrically erasable and programmable read-only memory (EEPROM), flash memory, or any other type of non-volatile memory. At least some of the memory device can include a non-transitory computer-readable medium from which the processor 402 can read the instructions 406. A computer-readable medium can include electronic, optical, magnetic, or other storage devices capable of providing the processor 402 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 406.

In some examples, the processor 402 can input a first system prompt 132 to a large language model 122. The processor 402 may input the first system prompt 132 to the large language model 122 at the start of an interaction session 416, for example prior to receiving a first user message for the large language model 122. The first system prompt 132 can include a first set of response parameters 412. The first set of response parameters 412 can include one or more response parameters. Based on receiving the first system prompt 132, the large language model 122 can enter a first functional state 140 that conforms to the first set of response parameters 412. While the large language model 122 is in the first functional state 140, the processor 402 can operate the large language model 122 to engage in an interaction 418 with the user 108 to thereby generate first interaction content 408.

In some examples, the processor 402 can determine that a condition 422 is satisfied based on the first interaction content 408. This determination can be made while the interaction session 416 is ongoing. Based on determining that the condition 422 is satisfied, the processor 402 can input a second system prompt 134 to the large language model 122. The second system prompt 134 can include a second set of response parameters 414 that is different from the first set of response parameters 412. The second set of response parameters 414 can include one or more response parameters. Based on receiving the second system prompt 134, the large language model 122 can enter a second functional state 142 that conforms to the second set of response parameters 414. While the large language model 122 is in the second functional state 142, the processor 402 can operate the large language model 122 to continue the interaction 418 with the user 108 to thereby generate second interaction content 410. This process may repeat one or more additional times over the remainder of the interaction 418.

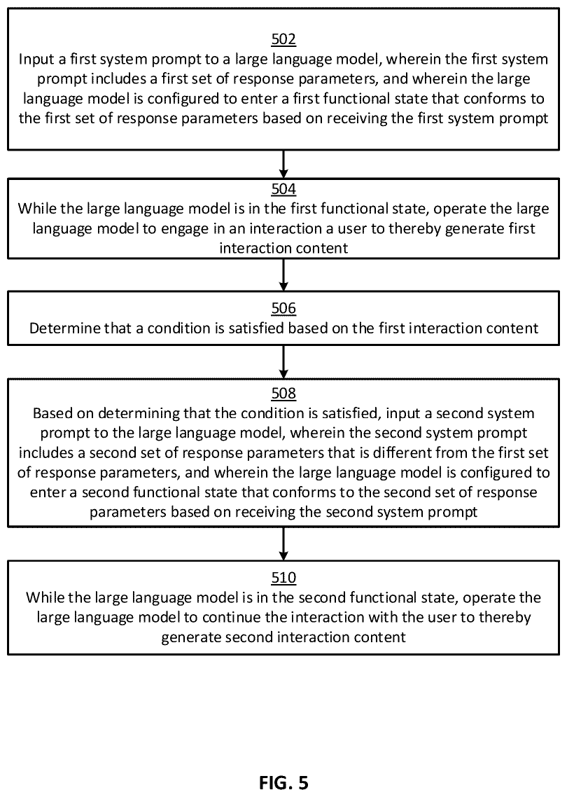

FIG. 5 shows a flow chart of an example of a process for dynamically adjusting response parameters of a large language model during an interaction, according to some aspects of the present disclosure. Other examples may include more steps, fewer steps, different steps, or a different sequence of steps than is shown in FIG. 5. The operations of FIG. 5 are described below with reference to the components of FIG. 4 described above.

In block 502, the processor 402 inputs a first system prompt 132 to a large language model 122. The processor 402 can input the first system prompt 132 to the large language model 122 prior to allowing user messages to be input to the large language model 122 during an interaction session 416. The first system prompt 132 can include a first set of response parameters 412. The large language model 122 is configured to enter a first functional state 140 that conforms to the first set of response parameters 412 based on receiving the first system prompt 132.

In block 504, while the large language model 122 is in the first functional state 140, the processor 402 operates (e.g., executes) the large language model 122 to engage in an interaction 418 with a user 108, to thereby generate first interaction content 408.

In block 506, the processor 402 determines that a condition 422 is satisfied based on the first interaction content 408. This determination can be made while the interaction 418 is ongoing.

In block 508, based on determining that the condition 422 is satisfied, the processor 402 inputs a second system prompt 134 to the large language model 122. The second system prompt 134 can include a second set of response parameters 414 that is different from the first set of response parameters 412. The large language model 122 is configured to enter a second functional state 142 that conforms to the second set of response parameters 414 based on receiving the second system prompt 134.

In block 510, while the large language model 122 is in the second functional state 142, the processor 402 operates the large language model 122 to continue the interaction 418 with the user 108 to thereby generate second interaction content 410. This process may repeat one or more additional times over the remainder of the interaction session 416.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A system comprising:
one or more processors; and
one or more memories storing program code that is executable by the one or more processors for causing the one or more processors to perform operations comprising:
inputting a first system prompt to a large language model, wherein the first system prompt includes a first set of response parameters, and wherein the large language model is configured to enter a first functional state that conforms to the first set of response parameters based on receiving the first system prompt;
while the large language model is in the first functional state, operating the large language model to engage in an interaction with a user to thereby generate first interaction content;
determining that a condition is satisfied based on the first interaction content;
based on determining that the condition is satisfied, inputting a second system prompt to the large language model, wherein the second system prompt includes a second set of response parameters that is different from the first set of response parameters, and wherein the large language model is configured to enter a second functional state that conforms to the second set of response parameters based on receiving the second system prompt; and
while the large language model is in the second functional state, operating the large language model to continue the interaction with the user to thereby generate second interaction content.

2. The system of claim 1, wherein the first set of response parameters includes a first role to be played by the large language model, and wherein the second set of response parameters includes a second role to be played by the large language model, the second role being different from the first role.

3. The system of claim 1, wherein the operations comprise executing a rule engine to determine whether the condition is satisfied, the rule engine being configured to apply a predefined set of rules against the first interaction content to determine whether one or more conditions are satisfied.

4. The system of claim 1, wherein the operations comprise:
based on determining that the condition is satisfied, selecting the second system prompt based on a correlation between the condition and the second system prompt in a predefined mapping, wherein the predefined mapping includes correlations between a plurality of conditions and a plurality of system prompts; and
based on selecting the second system prompt, inputting the second system prompt to the large language model.

5. The system of claim 1, wherein operating the large language model in the first functional state to engage in the interaction with the user involves:
receiving messages from the user;
providing the messages as input prompts to the large language model, the input prompts being distinct from the first system prompt and the second system prompt;
receiving responses to the messages as output from the large language model; and
providing the responses to the user, wherein the messages and the responses constitute the first interaction content.

6. The system of claim 1, wherein the operations comprise dynamically adjusting one or more response parameters of the large language model during the interaction by providing different system prompts as input to the large language model during the interaction in response to different conditions being satisfied during the interaction.

7. The system of claim 1, wherein the condition is a first condition, and wherein the operations comprise:
determining that a second condition is satisfied based on the second interaction content, the second condition being different from the first condition;
based on determining that the second condition is satisfied, inputting a third system prompt to the large language model, wherein the third system prompt includes a third set of response parameters that is different from the first set of response parameters and the second set of response parameters, and wherein the large language model is configured to enter a third functional state that conforms to the third set of response parameters in response to receiving the third system prompt; and
while the large language model is in the third functional state, operating the large language model to continue the interaction with the user to thereby generate third interaction content.

8. A computer-implemented method comprising:
inputting a first system prompt to a large language model, wherein the first system prompt includes a first set of response parameters, and wherein the large language model is configured to enter a first functional state that conforms to the first set of response parameters based on receiving the first system prompt;
while the large language model is in the first functional state, operating the large language model to engage in an interaction with a user to thereby generate first interaction content;
determining that a condition is satisfied based on the first interaction content;
based on determining that the condition is satisfied, inputting a second system prompt to the large language model, wherein the second system prompt includes a second set of response parameters that is different from the first set of response parameters, and wherein the large language model is configured to enter a second functional state that conforms to the second set of response parameters based on receiving the second system prompt; and
while the large language model is in the second functional state, operating the large language model to continue the interaction with the user to thereby generate second interaction content.

9. The method of claim 8, wherein the first set of response parameters includes a role parameter, a tone parameter, or a length parameter.

10. The method of claim 8, further comprising executing a rule engine to determine whether the condition is satisfied, wherein the rule engine applies a predefined set of rules against the first interaction content to determine whether one or more conditions are satisfied.

11. The method of claim 8, further comprising:
based on determining that the condition is satisfied, selecting the second system prompt based on a correlation between the condition and the second system prompt in a predefined mapping, wherein the predefined mapping includes correlations between a plurality of conditions and a plurality of system prompts; and
based on selecting the second system prompt, inputting the second system prompt to the large language model. 12 The method of claim 8, wherein operating the large language model in the first functional state to engage in the interaction with the user involves:
receiving messages from the user;
providing the messages as input prompts to the large language model, the input prompts being distinct from the first system prompt and the second system prompt;
receiving responses to the messages as output from the large language model; and
providing the responses to the user, wherein the messages and the responses constitute the first interaction content.

13. The method of claim 8, further comprising dynamically adjusting one or more response parameters of the large language model during the interaction by providing different system prompts as input to the large language model during the interaction in response to different conditions being satisfied by content of the interaction.

14. The method of claim 8, wherein the condition is a first condition, and further comprising:
determining that a second condition is satisfied based on the second interaction content, the second condition being different from the first condition;
based on determining that the second condition is satisfied, inputting a third system prompt to the large language model, wherein the third system prompt includes a third set of response parameters that is different from the first set of response parameters and the second set of response parameters, and wherein the large language model is configured to enter a third functional state that conforms to the third set of response parameters in response to receiving the third system prompt; and
while the large language model is in the third functional state, operating the large language model to continue the interaction with the user to thereby generate third interaction content.

15. A non-transitory computer-readable medium comprising program code that is executable by one or more processors for causing the one or more processors to perform operations comprising:
inputting a first system prompt to a large language model, wherein the first system prompt includes a first set of response parameters, and wherein the large language model is configured to enter a first functional state that conforms to the first set of response parameters based on receiving the first system prompt;
while the large language model is in the first functional state, operating the large language model to engage in an interaction with a user to thereby generate first interaction content;
determining that a condition is satisfied based on the first interaction content;
based on determining that the condition is satisfied, inputting a second system prompt to the large language model, wherein the second system prompt includes a second set of response parameters that is different from the first set of response parameters, and wherein the large language model is configured to enter a second functional state that conforms to the second set of response parameters based on receiving the second system prompt; and
while the large language model is in the second functional state, operating the large language model to continue the interaction with the user to thereby generate second interaction content.

16. The non-transitory computer-readable medium of claim 15, wherein:
the first set of response parameters includes a first length parameter, a first tone parameter, and a first role parameter; and
the second set of response parameters includes a second length parameter, a second tone parameter, and a second role parameter.

17. The non-transitory computer-readable medium of claim 15, wherein the operations comprise executing a rule engine to determine whether the condition is satisfied, the rule engine being configured to apply a predefined set of rules against the first interaction content to determine whether one or more conditions are satisfied.

18. The non-transitory computer-readable medium of claim 15, wherein the operations comprise:
based on determining that the condition is satisfied, selecting the second system prompt based on a correlation between the condition and the second system prompt in a predefined mapping, wherein the predefined mapping includes correlations between a plurality of conditions and a plurality of system prompts; and
based on selecting the second system prompt, inputting the second system prompt to the large language model.

19. The non-transitory computer-readable medium of claim 15, wherein the operations comprise dynamically adjusting one or more response parameters of the large language model during the interaction by providing different system prompts as input to the large language model during the interaction in response to different conditions being satisfied by content of the interaction.

20. The non-transitory computer-readable medium of claim 15, wherein the condition is a first condition, and wherein the operations comprise:
determining that a second condition is satisfied based on the second interaction content, the second condition being different from the first condition;
based on determining that the second condition is satisfied, inputting a third system prompt to the large language model, wherein the third system prompt includes a third set of response parameters that is different from the first set of response parameters and the second set of response parameters, and wherein the large language model is configured to enter a third functional state that conforms to the third set of response parameters in response to receiving the third system prompt; and
while the large language model is in the third functional state, operating the large language model to continue the interaction with the user to thereby generate third interaction content.
